(19) United States
(12) Patent Application Publication
(10) Pub. No.: US 2006/0136243 A1
(43) Pub. Date: Jun. 22, 2006

(54) Apparatus and method for administering a scholastic application program

(76) Inventor: Mark Cady, Mechanicsburg, PA (US)

Correspondence Address: ROBERT J. YARBROUGH, ATTORNEY AT LAW, 201 NORTH JACKSON STREET, MEDIA, PA, 19063, US

(21) Appl. No.: 11/019,873

(22) Filed: Dec. 22, 2004

(51) Int. Cl. G06Q 99/00

(52) U.S. Cl. 705/1

(57) ABSTRACT

The invention is an apparatus and method for administering a scholastic application program. An electronic transcript of a candidate is received by a clearinghouse from a school. The candidate selects one or more institutions and instructs the clearinghouse to transmit the electronic transcript to the institutions for the purpose of a screening review. The institutions receive the electronic transcript and perform automated reviews of the electronic transcript using pre-determined criteria. If the candidate satisfies the predetermined criteria for an institution, the candidate is invited to apply for admission by the institution.

### BACKGROUND OF THE INVENTION

1. Field of the Invention

The Invention relates to an apparatus and method for administering a program of applications to scholastic institutions, such as applications by prospective students to a college, university, graduate, technical or trade school.

2. Description of the Related Art

In the current college application process, a prospective student (referred to in this application as a “candidate”) identifies a college, university, graduate school, technical school or trade school (referred to in this application as an “institution”). The candidate then prepares an application for admission to the institution. The completed application includes certified transcripts of the candidate's grades in high school or college. The application also may include an essay prepared by the candidate. The candidate will submit the completed application to the institution and will pay an application fee to each such institution to cover the costs of the review of the application.

Upon receipt of the application, the institution assigns the application for review by one or more staff members. The staff members conduct a paper review of the application to form an opinion of the suitability of the candidate as a student in the institution. The institution notifies the student by mail as to whether the student has been accepted or rejected for admission.

Many institutions accept applications for admission electronically, over the Internet. The candidate will identify the institution to which he or she wishes to apply and will complete an online application. The candidate will submit the completed form along with the candidate's essay and electronic payment to the institution. The candidate will cause the candidate's high school or previous college transcripts to be forwarded to the institution. The institution will assign the application to one or more employees to review the application and will determine whether or not to accept the candidate. The institution will notify of the institution's decision whether to admit the candidate.

For students in certain geographic areas, a transcript data repository, or clearinghouse, currently is available to assist a candidate in electronically transmitting his or her transcripts to an institution. Under the current system, the candidate may authorize the clearinghouse to supply the transcripts electronically to a target institution as a part of an application for admission to the institution. The institution will request the transcript from the clearinghouse and the clearinghouse will electronically transmit the grades to the institution. The institution then will conduct its review and make a decision as described above for paper applications.

In each of the prior art systems, transcripts are submitted to the target institution as a part of a larger application and are reviewed by the institution as a part of the review of the larger application. None of the prior art systems provide for an electronic screening review of the transcripts by the institution prior to inviting an application from the candidate by the institution.

### SUMMARY OF THE INVENTION

The Invention is a method for administering scholastic applications. A candidate creates an account with a clearinghouse. For purposes of this application, a clearinghouse is an electronic information repository that may be resident on a clearinghouse computer. The clearinghouse computer is capable of securely communicating with the candidate and with schools and institutions over a computer network, such as the Internet.

The candidate authorizes a school that the candidate has attended to transmit electronic transcripts of the student over the computer network to the clearinghouse. For purposes of this application, the term “electronic transcripts” means an electronic file containing the grades or other indicia that indicate the performance of the candidate while attending the school. The school transmits the electronic transcripts of the candidate to the clearinghouse over the computer network. The electronic transcripts are encrypted for transmission or subject to other security to preserve the integrity of the electronic transcripts. The clearinghouse receives the transcript information from the school, associates the electronic transcript with the identity of the candidate, and stores the electronic transcript in computer memory.

The candidate also provides candidate data to the clearinghouse. In addition to the address or other contact information for the candidate, the candidate data includes an intended major for the candidate and may include any other information determined relevant by the clearinghouse or by an institution. The candidate data may include information relating to the candidate's extracurricular activities, interests or honors. The clearinghouse stores the candidate data in computer memory.

The candidate selects a plurality of institutions to conduct screening reviews of the electronic transcript and candidate data. The candidate authorizes the clearinghouse to submit the electronic transcript and candidate data to each of the selected institutions. The clearinghouse then forwards the electronic transcript and candidate data to the selected institutions. The electronic transcript and candidate data is encrypted or otherwise secured for transmission.

Each of the selected institutions receives the electronic transcript and candidate data from the clearinghouse. Each institution then conducts a screening review of the transcript data to determine whether the candidate is a prospect for the institution. The screening of the transcript data may be automated and may occur without human intervention. For an automated review of the transcript data, the institution applies predetermined screening criteria to the electronic transcript.

If the institution's screening review indicates that the candidate is a prospect for admission to the institution, the institution invites the candidate to apply for admission. If the institution places a significant priority in admissions on factors not amenable to an automated review, such as the quality of the essay or upon extracurricular activities of the applicant, the institution may so advise the candidate in reporting the results of the screening review. The institution may advise the candidate of the admissions success of prior candidates in prior years who submitted transcripts similar to those of the candidate.

If the screening review indicates that the candidate is qualified, the institution assigns a recruitment priority to the candidate based on the results of the screening review. For example, if the candidate data shows that the candidate is a tuba player and intends to major in music, an institution in need of tuba players for the marching band may assign a high recruitment priority to the candidate. The institution targets its recruitment efforts and expenditures based on the recruitment priority assigned to the candidate.

The candidate reviews the screening reviews from a plurality of institutions and selects to which institutions the candidate will apply. The candidate submits complete applications as in the prior art, including a completed admissions form, the candidate's essay and payment of the application fees. Each selected institution then will conduct an examination of the full application and will decide whether to accept the candidate for admission. Each selected institution then delivers a notice of acceptance or rejection to the candidate.

The request for the screening review by the candidate may be Internet-enabled, allowing a candidate to direct the clearinghouse to transmit the candidate's electronic transcript and candidate data to any number of institutions in any geographic locations at the same time from within an Internet browser on a client computer operated by the candidate. The automated nature of the screening review by the institutions allows the review to be conducted in a matter of seconds and the results of the screen to be transmitted by the institutions immediately to the candidate and received within the Internet browser. Since the screening review is automated and does not require human intervention, the review may be conducted at no or nominal cost either to the institution or to the candidate.

The screening review provides the candidate a ‘reality check’ on the likelihood of success in applying to a particular institution. If a candidate is clearly not qualified for a particular institution but is qualified for a different institution, the screening evaluation would help the candidate to identify the institutions for which the candidate is qualified. Should the candidate be dissatisfied with the results of the screening review of a particular institution, the candidate may nonetheless submit a full application for admission to the institution.

To assist the candidate in making an informed decision, an institution can provide the candidate with an estimate of past year admissions successes of prior year candidates having transcripts similar to the electronic transcript of the candidate. For example, if 47% of applicants with transcript grades similar to those of the candidate were admitted in past years, then the institution may so advise the candidate. The candidate may use this information in making an informed decision in choosing institutions to which he or she will apply.

### BRIEF DESCRIPTION OF THE DRAWINGS

FIG. 1 is an illustration of the flow of information where the institution conducts screening and advises the candidate of the screening results.

FIGS. 2A, 2B and 2C comprise a flow chart of the method of the Invention from the perspective of a candidate.

FIGS. 3A and 3B comprise a flow chart of the method of the Invention from the perspective of the institution.

FIGS. 4A and 4B comprise a flow chart of the method of the Invention where the institution provides a likelihood of admission to the candidate.

FIG. 5 shows an alternative embodiment where the institution transmits the screening results to the clearinghouse.

FIG. 6 shows an alternative embodiment where the clearinghouse conducts the screening review on behalf of the institution.

FIG. 7 shows an alternative embodiment where the institution prepares an estimate of the likelihood of admission of the candidate.

### DESCRIPTION OF AN EMBODIMENT

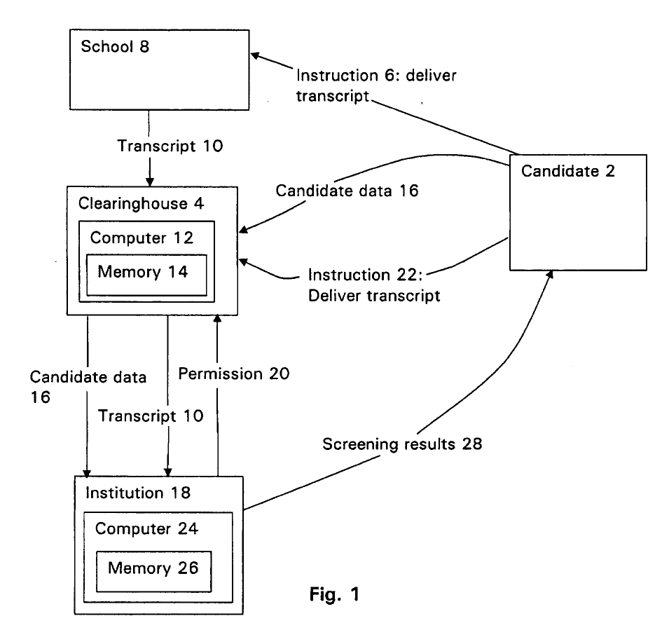

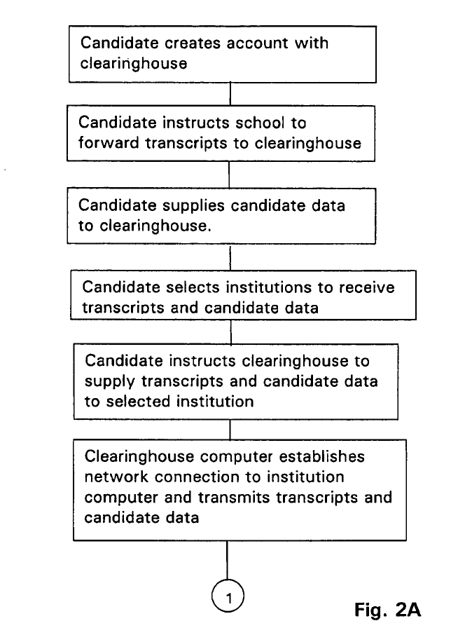

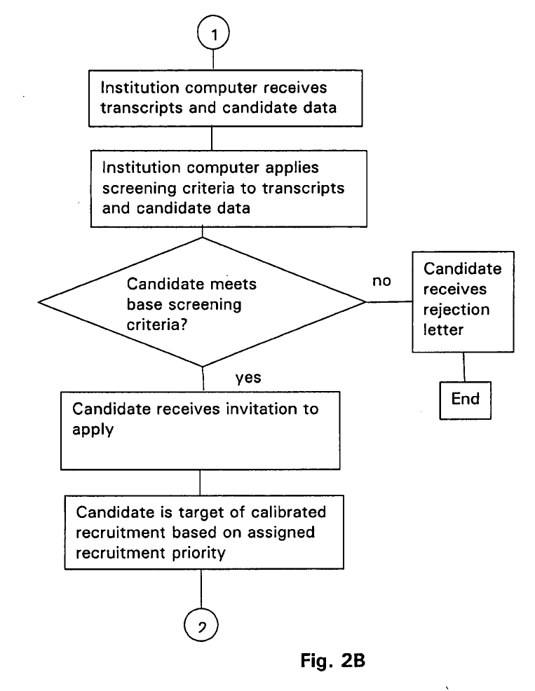

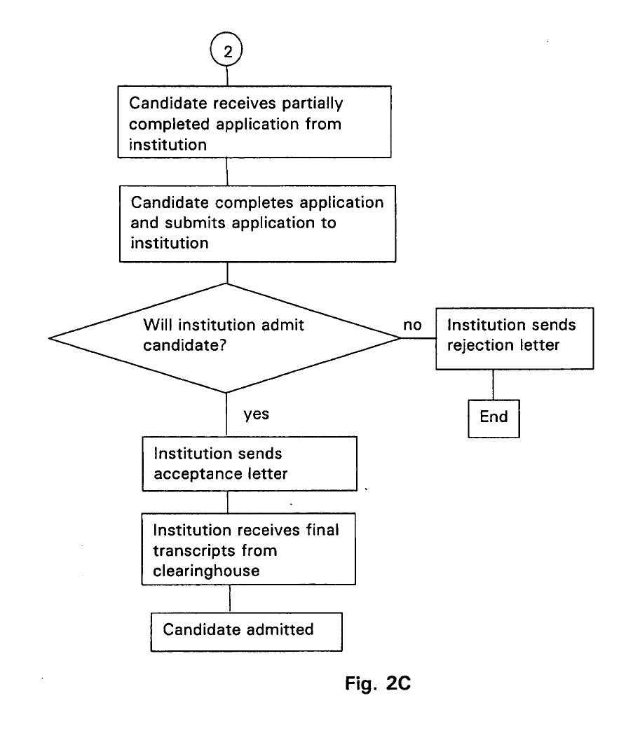

The following paragraphs refer to FIGS. 1 and 2A-2C. FIG. 1 illustrates the information flow of the Invention. FIGS. 2A-2C show the method of the Invention from the perspective of the candidate 2.

As shown by FIGS. 1 and 2A, Candidate 2 opens an account with clearinghouse 4. Candidate 2 may open the account by using a computer network connection over the Internet. A candidate 2 is any person seeking admission into a scholastic program. For example, the candidate 2 may be a high school student exploring options for college. Where candidate 2 is a minor, a parent or guardian may act on the candidate's 2 behalf. The candidate 2 issues an instruction 6 to the candidate's 2 current or past school 8. The instruction 6 directs the school 8 to forward the candidate's 2 electronic transcripts 10 to a clearinghouse 4.

The school 8 forwards the electronic transcripts 10 of candidate 2 as an encrypted electronic file to clearinghouse 4. The electronic transcripts 10 are transmitted over a computer network, such as the Internet. The electronic transcripts 10 are received by the clearinghouse 4 by a clearinghouse computer 12, where the electronic transcript 10 is associated with candidate 2 and stored in clearinghouse computer memory 14.

Candidate 2 also submits candidate data 16 to clearinghouse 4. Candidate data 16 may include an intended major, such as music, of candidate 2. Candidate data 16 also may include other information as specified by clearinghouse 4 or as specified by an institution 18. Since the review of the candidate data 16 is automated, either numeric data such as a the candidate's 2 Zip code, or data denoted by a selection among alternatives such as yes/no questions, is most useful.

The clearinghouse 4 presents candidate 2 with a plurality of institutions 18 from which to select. The clearinghouse 4 previously negotiated permission 20 with each of the presented institutions 18 for the clearinghouse 4 to submit information electronically to the institution 18.

Candidate 2 selects one or more institutions 18 that candidate 2 wishes to investigate and transmits an instruction 22 to clearinghouse 4 to send the electronic transcripts 10 and candidate data 16 to institution 18 for the purpose of a screening review by institution 18. The clearinghouse 4 causes the clearinghouse computer 12 to transmit the electronic transcript 10 and candidate data 16 over the computer network to the institution 18. The institution 18 receives the electronic transcript 10 and candidate data 16 in an institution computer 24 and stores the electronic transcript 10 and candidate data 16 in institution computer memory 26.

The institution 18 conducts a screening review of the transcript 10 and candidate data 16. The institution 18 generates result 28 of the screening review and transmits result 28 directly to candidate 2.

As shown by FIG. 2B, the screening review may result 28 in the rejection of the candidate 2 as not meeting minimum qualifications. The candidate 2 receives a rejection notice and the process is at an end. The candidate 2 then pursues his or her career through other means.

If the candidate 2 meets minimum qualifications, the candidate 2 may be invited to apply formally to the institution 18. The candidate 2 may receive targeted recruitment materials from the institution 18, such as brochures and invitations to visit. If the candidate 2 is particularly well qualified or if the candidate data 16 shows that the candidate 2 meets an identified need of the institution 18, recruitment may include personal visits by recruiters, offers of scholarships or other financial aid.

As shown by FIG. 2C, the institution 18 may forward the qualified candidate 2 a partially completed application form, which may be an electronic form. If the candidate 2 chooses to apply formally to the institution 18, the candidate 2 may complete the application and submit the application to the institution 18.

If, based on the full application, the institution 18 rejects the application, the institution 18 will notify the candidate 2 of the rejection and the process is at an end. If the institution 18 accepts the candidate 2 based on the formal application, the institution 18 notifies the candidate 2. The candidate 2 causes the clearinghouse 4 to submit the candidate's 2 final electronic transcripts 10 to the institution 18 at the end of the school year to satisfy this condition for admission. The candidate 2 then if finally admitted as a student of the institution 18.

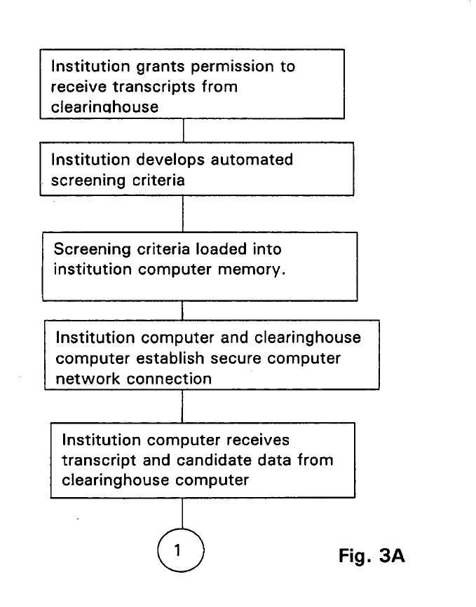

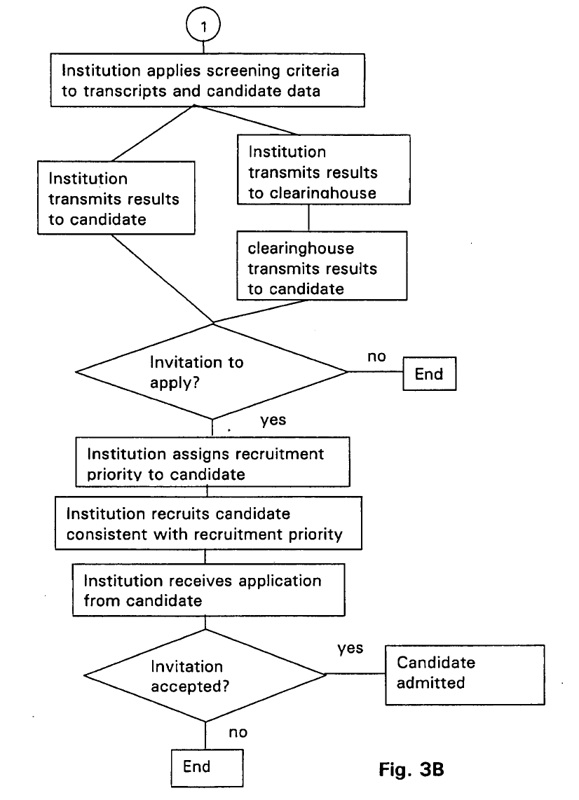

FIGS. 3A and 3B comprise a flow chart illustrating the method of the Invention from the perspective of the institution 18. As shown by FIG. 3A, the institution 18 negotiates with the clearinghouse 4 and grants permission 20 to the clearinghouse 4 for the clearinghouse 4 to provide electronic transcripts 10 and candidate data 16 electronically to the institution 18.

The institution 18 develops automated screening criteria to be applied by the institution computer 24 to electronic transcripts 10 and candidate data 16 received by the institution 18 for the purposes of a screening review. The screening criteria may be of any nature desired by the institution 18. For example, the screening criteria may reject any candidate 2 who does not exhibit a grade point average of 3.0 out of 4.0 or better. The screening criteria may weight the transcript data based on the school 8 from which the transcript originated, for example automatically increasing transcript scores for a demanding school 8 and discounting transcript scores for an undemanding school 8. The screening criteria may weight by geographic area, for example, a local college with a mission of educating local youth may rank a local resident higher than an equally qualified resident of a distant state. The screening criteria may look for special needs of the institution 18, as in the example of the tuba player.

The screening criteria developed by the institution 18 are loaded in the institution computer memory 26. The institution computer 24 receives an electronic transcript 10 and candidate data 16 from the clearinghouse 4 over a computer network and applies the screening criteria to the transcript and candidate data 16.

The term ‘computer network’ means any connection allowing one computer to communicate with another computer and may include the Internet. The institution 18 determines whether the candidate 2 meets minimum qualifications.

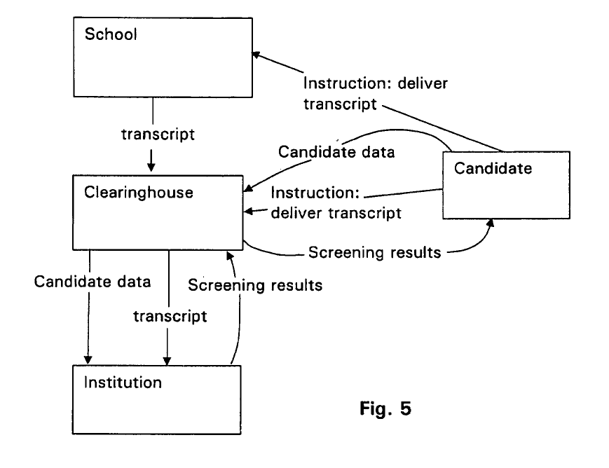

If not, the institution 18 transmits a rejection notice to the candidate 2. As an alternative shown by FIGS. 3B and 5, direct communications with the candidate 2 may occur through the clearinghouse 4. The institution 18 may transmit the results 28 of the screening review to the clearinghouse 4, which stores the results 28 in clearinghouse computer memory 14. The candidate 2 may receive the results 28 of the screening review by electronic mail or may log on to his or her account with the clearinghouse 4 to view the results.

Since all review and communication is automated, the candidate 2 is able to view the results 28 of the screening review within a short time after submitting the request 22 for screening review. Since the cost of the screening review to the candidate 2, the clearinghouse 4 and the institution 18 is small, the candidate 2 is able to obtain screening reviews from a larger number of institutions 18 than the candidate 2 would otherwise consider.

The result 28 may be that the institution 18 concludes that a candidate 2 is unqualified. The institution 18 does not invite the candidate 2 to apply, which may be the end of the matter.

As shown by FIG. 3B, if the candidate 2 meets minimum qualifications, the institution 18 will invite the candidate 2 to apply formally for admission and will assign a recruitment priority to the candidate 2. The institution 18 then will recruit the candidate 2 based on the assigned recruitment priority. Recruitment may involve mailing packages of materials to the candidate 2, contacting the candidate 2 directly or offering financial or other incentives to the candidate 2.

The institution 18 may supply the candidate 2 with a partially completed application or with other assistance in applying for admission. The candidate 2 completes the admissions form and supplies other information required for a full application to the institution 18. The institution 18 will make a final decision to admit or not admit the candidate 2 based on a review of the full application.

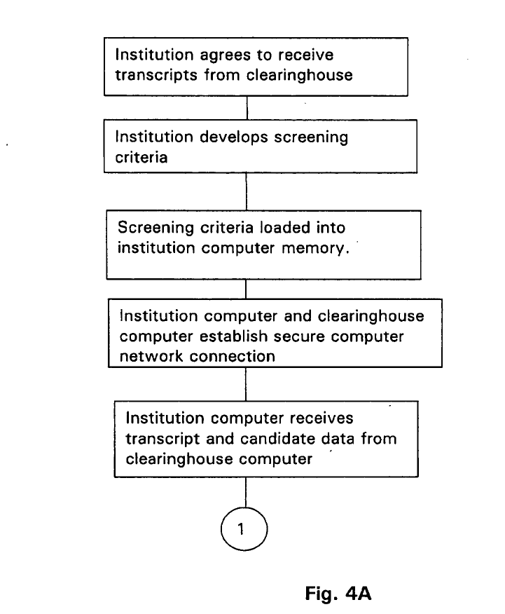

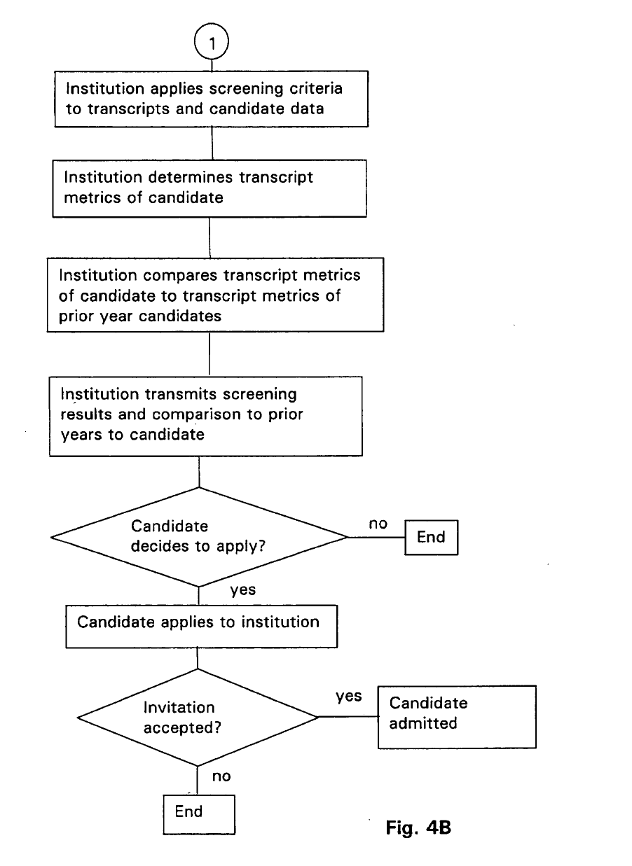

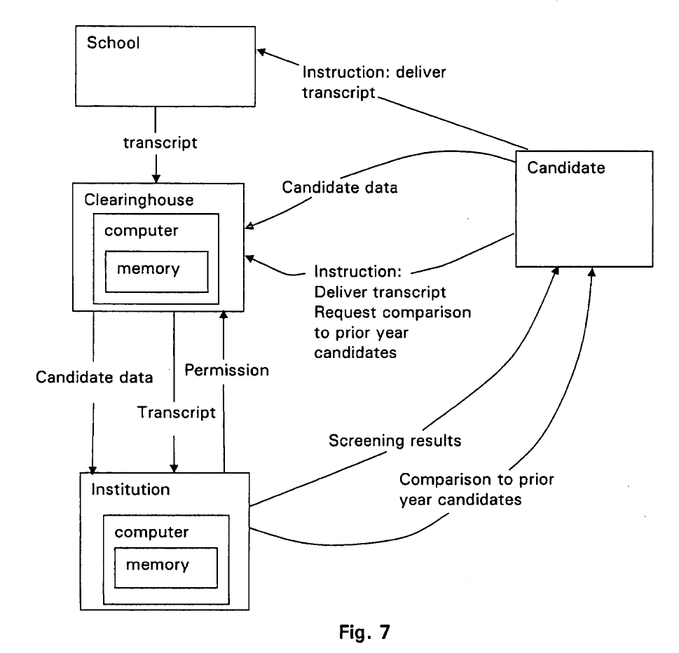

FIGS. 4A, 4B and 7 illustrate an alternative embodiment where the result 28 of the screening review includes a comparison 32 of the electronic transcript 10 of the candidate 2 to the prior year transcripts of prior year candidates. The comparison 32 provides the candidate 2 with some guide to the likelihood of successful admission to the institution 18 and allows the institution 18 to provide the candidate 2 with something other than an outright rejection as a result 28 of the screening review.

As shown by FIG. 7, the candidate 2 requests 30 a comparison to past year admissions by past year candidates at the time that the candidate 2 instructs the clearinghouse 4 to forward the candidate's 2 electronic transcripts 10 to the institution 18 for a screening review. The clearinghouse 4 transmits the transcript 10 to the institution 18 along with the request 22 for the screening review and the request 30 for a comparison to past year admissions. The institution 18 performs the screening review and compares the electronic transcript of the candidate 2 to those of candidates who applied for admission in prior years. The institution 18 transmits to the candidate 2 the results 28 of the screening review, including the comparison to past year candidates 32.

To compare the candidate's 2 electronic transcript 10 to those of prior year candidates and as described in FIGS. 4A and 4B, the institution 18 determines transcript metrics for a plurality of candidates for past years. A “transcript metric” is any measurement relating to a transcript 10 that the institution 18 may find useful. For example, the institution 18 may create four transcript metrics relating to math, science, English and social studies. For each transcript metric, the institution 18 may establish a range, for example 1 to 4. For a candidate 2 with, say, a solid ‘B’ average in English from a demanding school 8, the institution 18 may assign an English transcript metric of 3. The institution 18 assigns similar values for the other transcript metrics associated with the candidate's 2 transcript.

The institution 18 creates a database of transcript metrics for a plurality of prior candidates who applied for admission to the institution 18 in prior years. The institution 18 also includes in the database whether or not each of the prior candidates was accepted for admission to the institution 18.

The institution 18 compares the transcript metrics derived for the candidate 2 to the database and determines what proportion of the past year candidates having transcript metrics equivalent to those of the candidate 2 were accepted by the institution 18. For example, the institution 18 may determine that the transcript metrics of the candidate 2 are better than the transcript metrics of 47% of the prior year candidates accepted by the institution 18, indicating that the candidate 2 has a reasonable chance of being accepted by the institution 18. The result 32 is transmitted to the candidate 2.

The institution 18 may present the results 32 of the comparison in any manner desirable to the institution 18. For example, the institution 18 may combine the candidate's 2 transcript metrics into a single number and may combine the transcript metrics of the prior year candidates into a range of numbers. If the candidate's 2 single number falls below range of numbers for prior year candidates, the institution 18 may prohibit or discourage the candidate 2 from applying.

The transcript metrics do not, of course, measure all aspects of the candidate 2 or provide the candidate 2 with a hard and fast rejection or guarantee of acceptance. The results 32 of the evaluation provide the student with a reasonably objective appraisal of how candidates with grades similar to those of the candidate 2 have fared in the past. For example, if the candidate 2 is interested in Harvard, but only 5% of the past year candidates with grades similar to those of the candidate 2 have been accepted to Harvard, then the candidate 2 may choose to direct his or her energies elsewhere. Conversely, a candidate 2 who is a gifted writer, musician or athlete may choose to apply, since those extraordinary talents may not be considered by the transcript metric evaluation.

The process of harvesting data, constructing the database of past year transcript metrics and comparing the electronic transcripts 10 of the candidate 2 to those of prior year candidates can be performed by an automated institution 18 computer system 24.

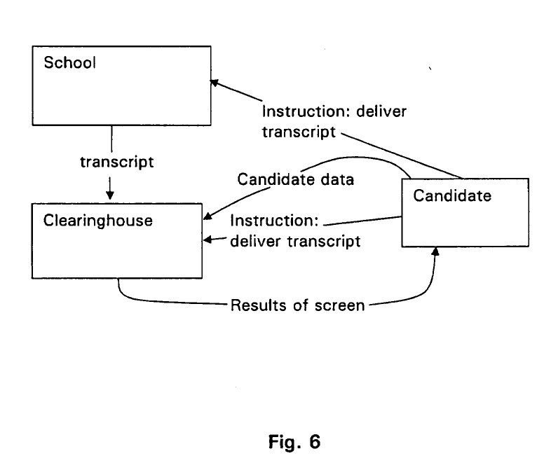

The screening review functions described in FIGS. 1-4B as being performed by the institution 18 may be performed by the clearinghouse 4 on behalf of the institution 18, as shown by FIGS. 5 and 6. FIG. 5 illustrates an embodiment where all communications with the candidate 2 relating to the screening review go through the clearinghouse. The clearinghouse 4 receives the results 28 of the screening review conducted by the institution 18 and either transmits the results 28 to the candidate 2 or allows the candidate 2 to view the results 28 by accessing the candidate's 2 account on the clearinghouse's 4 Internet web site.

FIG. 6 shows an embodiment where the clearinghouse 4 performs the actual screening review on behalf of the institution 18. Since the screening review is entirely automated, the physical location of the computer performing the screening review is unimportant. The computer performing the screening review may be the clearinghouse computer 12 utilizing screening criteria determined by the institution 18.

The clearinghouse 4 also may either construct a database of prior year candidates or receive such a database from the institution 18. The clearinghouse 4 may then determine transcript metrics for the candidate 2 and compare the candidate's 2 transcript metrics to transcript metrics for prior year candidates to determine the likelihood of acceptance of the candidate 2 by the institution 18.

As used in this application, the term “school” 8 means a high school or college previously attended by the candidate 2.

In describing the above embodiments of the invention, specific terminology was selected for the sake of clarity. However, the invention is not intended to be limited to the specific terms so selected, and it is to be understood that each specific term includes all technical equivalents that operate in a similar manner to accomplish a similar purpose.

I claim:

1. A method for administering scholastic applications comprising the steps of:
a. receiving by a clearinghouse of an electronic transcript from a school, said electronic transcript being associated with a performance by a candidate;
b. storing by said clearinghouse of said electronic transcript in a clearinghouse computer memory;
c. receiving by said clearinghouse of a permission from an institution, said permission authorizing said clearinghouse to transmit said electronic transcript to said institution;
d. receiving by said clearinghouse from said candidate of an instruction, said instruction directing said clearinghouse to obtain for said candidate a screening review of said electronic transcript by submitting said electronic transcript to said institution;
e. transmitting by said clearinghouse of said electronic transcript to said institution.

2. The method of claim 1, the method further comprising the step of: providing by said clearinghouse of an opportunity for said candidate to select said institution from among a plurality of said institutions.

3. The method of claim 2, the method further comprising the steps of:
a. providing by said clearinghouse to said candidate an opportunity to select candidate data, said candidate data including an intended major of said candidate;
b. receiving said candidate data by said clearinghouse;
c. transmitting said candidate data by said clearinghouse to said institution.

4. The method of claim 3 wherein each of said steps of receiving or transmitting said electronic transcript or said electronic authorization comprises receiving or transmitting said electronic transcript or said electronic authorization over a computer network.

5. The method of claim 4 wherein said computer network is an internet.

6. The method of claim 5 wherein said opportunity to select candidate data includes said opportunity to select candidate data specified by said institution.

7. The method of claim 5, further comprising:
a. receiving by said clearinghouse of a result of said screening review by said institution;
b. transmitting by said clearinghouse to said candidate of said result of said screening review by said institution.

8. The method of claim 1, further comprising:
a. receiving by said clearinghouse from said candidate of a request for a comparison to prior year admissions to said institution;
b. determining a transcript metric for said candidate;
c. comparing said transcript metric of said candidate to a plurality of prior year transcript metrics corresponding to a plurality of prior year candidates;
d. determining a comparison of prior year admissions to said candidate based on said comparison of said transcript metric to said plurality of prior year transcript metrics;
e. transmitting said likelihood of admission to said candidate.

9. An apparatus for administering a scholastic education program, the apparatus comprising:
a. a clearinghouse computer programmed to receive an electronic transcript, said electronic transcript being associated with a performance of a candidate;
b. said clearinghouse computer having a computer memory, said clearinghouse computer being programmed to store said electronic transcript in said computer memory;
c. said clearinghouse computer being programmed to receive a permission from an institution, said permission authorizing said clearinghouse to transmit said electronic transcript to said institution;
d. said clearinghouse computer being programmed to receive from said candidate an instruction to submit a request for screening review to said institution;
e. said clearinghouse computer being programmed to transmit said request for screening review and said electronic transcript to said institution.

10. The apparatus of claim 9 further comprising: a computer network, said clearinghouse computer being programmed to communicate over said computer network with said institution and said candidate.

11. The apparatus of claim 10 wherein said computer network is an Internet.

12. The apparatus of claim 11 wherein said clearinghouse computer is programmed to provide said candidate an opportunity to select said institution from among a plurality of said institutions.

13. The apparatus of claim 12 wherein said clearinghouse computer is programmed to receive candidate data and to provide said candidate data to said institution, said candidate data including an intended major of said candidate.

14. A method for administering scholastic applications, the method comprising the steps of:
a. developing by an institution of an automated transcript screening criteria;
b. granting a permission by said institution for a clearinghouse to transmit an electronic transcript to said institution for purposes of a screening review, said electronic transcript being associated with a candidate, said electronic transcript not being accompanied by an application for admission to said institution;
c. receiving by said institution of said electronic transcript;
d. storing in an institution computer memory of said electronic transcript by said institution;
e. screening said electronic transcript by said institution by automated application of said automated transcript screening criteria to said electronic transcript by said institution computer;
f. transmitting to said candidate of a result of said screening of said electronic transcript by said institution.

15. The method of claim 14 wherein said steps of receiving said transcript and transmitting said result of said screening to said candidate occur over a computer network.

16. The method of claim 15 wherein said computer network is an Internet.

17. The method of claim 16, further comprising: assigning by said institution of a recruitment priority to said candidate.

18. The method of claim 17, further comprising: recruiting said candidate by said institution, said recruitment of said candidate having a degree, said degree of said recruitment being determined by said recruitment priority.

19. The method of claim 14 further comprising: inviting by said institution to said candidate for said candidate to apply for admission to said institution.

20. The method of claim 19, comprising the further sequential steps of:
a. receiving by said institution from said candidate of said application for admission, said institution receiving said application after transmitting to said candidate said result of said screening of said electronic transcript associated with said candidate;
b. evaluating said application by said institution;
c. making a decision by said institution of whether to admit said candidate;
d. notifying said candidate of said decision of whether to admit said candidate.

21. The method of claim 14, comprising the following additional steps:
a. receiving a request to determine a comparison to prior year admissions to said candidate;
b. determining a transcript metric for said candidate by said institution;
c. comparing said transcript metric of said candidate to a plurality of prior year transcript metrics corresponding to a plurality of prior year candidates;
d. determining said comparison to prior year admissions to said candidate based on said comparison of said transcript metric to said plurality of prior year transcript metrics;
e. transmitting to said candidate said comparison to prior year admissions.

22. An apparatus for administering a scholastic application program, the apparatus comprising:
a. an institution computer, said institution computer having a computer memory;
b. automated transcript screening criteria resident in said computer memory, said institution computer being programmed to apply said automated transcript screening criteria to an electronic transcript;
c. a computer network;
d. said institution computer being programmed to receive an electronic transcript from a clearinghouse computer over said computer network, said electronic transcript being associated with a candidate;
e. said institution computer being programmed to store said electronic transcript in said computer memory;
f. said institution computer being programmed to screen said electronic transcript by applying said screening criteria to said electronic transcript;
g. said institution computer being programmed to transmit to said candidate a result of said screening of said electronic transcript.

23. The apparatus of claim 22 wherein said computer network is an Internet.

24. The apparatus of claim 23 wherein said institution computer is programmed to receive candidate data from said clearinghouse, said candidate data including an intended major of said candidate, said institution computer being further programmed to consider said candidate data in said applying of said screening criteria.

25. The apparatus of claim 24 wherein said institution computer is programmed to assign a recruitment priority to said candidate, said recruitment priority being determined by said result of said screening.

26. The apparatus of claim 25, further comprising:
a. said institution computer being adapted to determine a transcript metric for said candidate;
b. said institution computer being adapted to determine a comparison to prior year admissions for said candidate by comparing said transcript metric for said candidate to a plurality of prior year transcript metrics corresponding to a plurality of prior year candidates;
c. said institution computer being adapted to incorporate said comparison to prior year admissions into said result of said screening step and to transmit to said candidate said comparison to prior year admissions.
